(19) United States
(12) Patent Application Publication
(10) Pub. No.: US 2024/0118601 A1
(43) Pub. Date: Apr. 11, 2024

(54) HOLOGRAM OPTICAL MEMBER, HOLOGRAM SCREEN, AND DISPLAY APPARATUS

(71) Applicant: SONY GROUP CORPORATION, TOKYO (JP)

(72) Inventors: AKIRA TANAKA, TOKYO (JP); NORIYUKI HIRAI, TOKYO (JP)

(21) Appl. No.: 18/548,279

(22) PCT Filed: Jan. 13, 2022
(86) PCT No.: PCT/JP2022/000911

§ 371 Date: Aug. 29, 2023

(30) Foreign Application Priority Data
Mar. 5, 2021 (JP) 2021-035855

(51) Int. Cl. G03B 21/62; G02B 1/14; G02B 5/32

(52) U.S. Cl. CPC G03B 21/62; G02B 1/14; G02B 5/32

(57) ABSTRACT

A hologram optical member of the present disclosure includes a hologram layer, a substrate, and a hard coat layer. The substrate includes a resin material. The hard coat layer is disposed between the hologram layer and the substrate, includes an organic-based material, and has a hardness higher than that of the substrate.

### TECHNICAL FIELD

The present disclosure relates to a hologram optical member including a hologram layer, to a hologram screen, and to a display apparatus.

### BACKGROUND ART

There has been proposed a display apparatus using a hologram screen having a cylindrical shape (see PTL 1). Meanwhile, there has been proposed a technique, regarding a hologram optical member including a substrate and a hologram layer, that improves performance such as moisture resistance or abrasion resistance by coating respective surfaces of the substrate and the hologram layer with ambient-temperature glass (see PTL 2).

### CITATION LIST

### Patent Literature

PTL 1: International Publication No. WO2018/163945
PTL2: Japanese Unexamined Patent Application Publication No. H6-258996

### SUMMARY OF THE INVENTION

Due to problems related to hardness, brittleness, and the like, it is difficult to apply a technique of coating with ambient-temperature glass to a hologram screen having a cylindrical shape, etc.

It is desirable to provide a hologram optical member, a hologram screen, and a display apparatus that each have high environment resistance.

A hologram optical member according to an embodiment of the present disclosure includes a hologram layer, a substrate, and a hard coat layer. The substrate includes a resin material. The hard coat layer is disposed between the hologram layer and the substrate, includes an organic-based material, and has a hardness higher than that of the substrate.

A hologram screen according to an embodiment of the present disclosure includes a hologram layer, a substrate, and a hard coat layer. The substrate includes a resin material. The hard coat layer is disposed between the hologram layer and the substrate, includes an organic-based material, and has a hardness higher than that of the substrate.

A display apparatus according to an embodiment of the present disclosure includes a hologram screen that displays an image. The hologram screen includes a hologram layer, a substrate, and a hard coat layer. The substrate includes a resin material. The hard coat layer is disposed between the hologram layer and the substrate, includes an organic-based material, and has a hardness higher than that of the substrate.

In the hologram optical member, the hologram screen, or the display apparatus according to the embodiment of the present disclosure, the hard coat layer including the organic-based material is disposed between the hologram layer and the substrate.

### BRIEF DESCRIPTION OF DRAWINGS

FIG. 1 is a cross-sectional view of a configuration example of a hologram optical member according to a comparative example.

FIG. 2 is a cross-sectional view of a first configuration example of a hologram optical member according to a first embodiment of the present disclosure.

FIG. 3 is a characteristic diagram illustrating an example of a diffraction characteristic of the hologram optical member according to the comparative example.

FIG. 4 is a characteristic diagram illustrating an example of a diffraction characteristic of the hologram optical member according to the first configuration example of the first embodiment.

FIG. 5 is an explanatory diagram presenting a comparison in terms of various characteristics between ambient-temperature glass and an organic-based hard coat.

FIG. 6 is a cross-sectional view of a second configuration example of the hologram optical member according to the first embodiment.

FIG. 7 is a characteristic diagram illustrating an example of the diffraction characteristic of the hologram optical member according to the comparative example.

FIG. 8 is a characteristic diagram illustrating an example of a diffraction characteristic of the hologram optical member according to the second configuration example of the first embodiment.

FIG. 9 is a characteristic diagram illustrating an example of a result of a measurement in which a 90° falling-off test is performed on the hologram optical member according to the second configuration example of the first embodiment.

FIG. 10 is a characteristic diagram presenting a comparison in terms of various characteristics between different materials to be included in an OCA layer.

FIG. 11 is a characteristic diagram presenting a comparison in terms of the diffraction characteristic between different materials to be included in the OCA layer.

FIG. 12 is a cross-sectional view of a third configuration example of the hologram optical member according to the first embodiment.

FIG. 13 is a cross-sectional view of a configuration example of a display apparatus according to the first embodiment.

FIG. 14 is a cross-sectional view of a main part of a configuration example of a hologram screen according to a comparative example.

FIG. 15 is a cross-sectional view of a main part of a configuration example of a hologram screen according to the first embodiment.

### MODES FOR CARRYING OUT THE INVENTION

In the following, some embodiments of the present disclosure are described in detail with reference to the drawings. It is to be noted that the description is given in the following order.

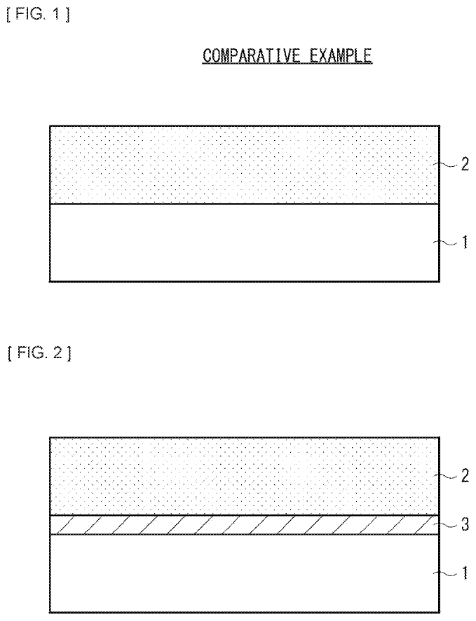

### 0. Comparative Example (FIG. 1)

### 1. First Embodiment

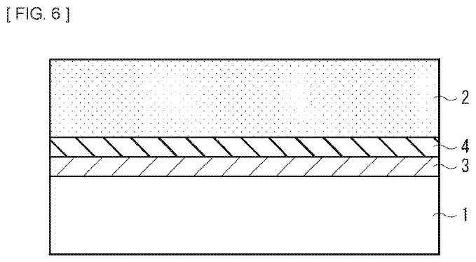

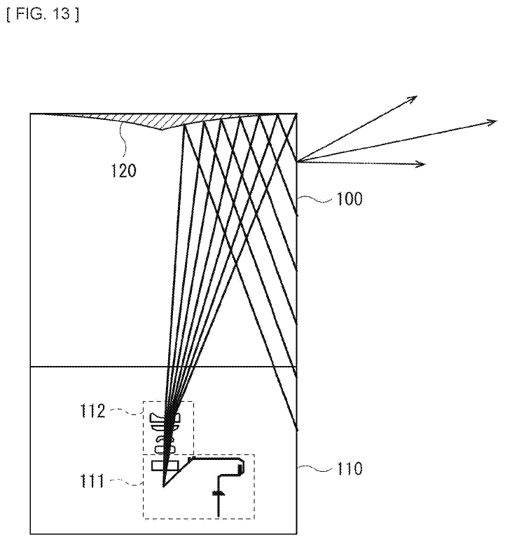

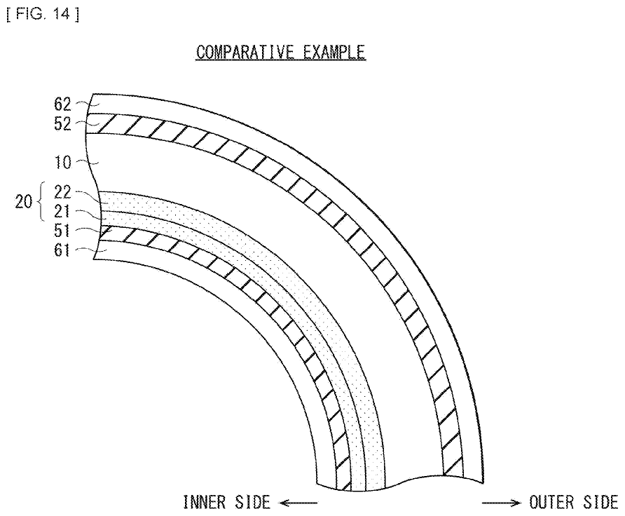

1.1 Configuration and Workings of Hologram Optical Member
   1.1.1 Hologram Optical Member Including Hard Coat Layer (FIG. 2 to FIG. 5)
   1.1.2 Hologram Optical Member Including Optical Clear Adhesive Layer (FIG. 6 to FIG. 12)
1.2 Example of Application to Display Apparatus (FIG. 13 to FIG. 15)
1.3 Effects

### 2. Other Embodiments

### 0. Comparative Example

### Overview and Issue of Hologram Optical Member According to Comparative Example

FIG. 1 illustrates a configuration example of a hologram optical member according to a comparative example.

One basic configuration of a hologram optical member is, for example, a configuration in which an HOE (Holographic Optical Element) layer 2 as a hologram layer is stacked on a substrate 1 including a resin material.

Meanwhile, as a display apparatus, a display apparatus that uses a hologram screen and has high transparency and brightness has been developed. For example, there has been proposed a display apparatus that makes it possible to display an image on an entire circumference of a hologram screen by using a cylindrical hologram screen as an object to which projection light is applied (see PTL 1).

In a case where the hologram screen has a configuration similar to that of the hologram optical member according to the comparative example illustrated in FIG. 1, a stress due to thermal expansion and thermal contraction of the substrate 1 is applied to the HOE layer 2. Although this also applies to a general flat-plate-shaped hologram screen, in the cylindrical hologram screen, a greater stress due to the thermal expansion and thermal contraction of the substrate 1 is applied to the HOE layer 2. Therefore, a load of an actual use environment makes it difficult to ensure reliability. For example, the thermal expansion and thermal contraction of the substrate 1 results in poor appearance and lower designability due to falling off of the HOE layer 2. It also causes deterioration of a diffraction characteristic, thus making it difficult to appropriately diffract the projection light on the hologram screen. This makes it difficult to achieve bright display.

To address such issues, there is a technique of coating respective surfaces of the substrate 1 and the HOE layer 2 with ambient-temperature glass (see PTL 2). The substrate 1 including the resin material is lower in moisture resistance, abrasion resistance, and solvent resistance than a glass substrate. Consequently, moisture or an organic solvent can penetrate the HOE layer 2 bonded to the substrate 1, which can cause a hologram recorded in the HOE layer 2 to disappear. Thus, such issues are solved by coating the substrate 1, the HOE layer 2, and an unillustrated adhesive with the ambient-temperature glass.

However, it is difficult to apply the technique of coating with the ambient-temperature glass to the cylindrical hologram screen, etc., because the ambient-temperature glass can break due to its hardness and brittleness. In a case of using the technique on the substrate 1 including the resin material, in particular, the ambient-temperature glass breaks more easily at a high temperature due to a difference in linear expansion between the ambient-temperature glass and the resin material.

### 1. First Embodiment

### 1.1 Configuration and Workings of Hologram Optical Member

### [1.1.1 Hologram Optical Member Including Hard Coat Layer]

FIG. 2 illustrates a first configuration example of a hologram optical member according to a first embodiment of the present disclosure.

The hologram optical member according to the first embodiment is applicable, for example, to a hologram screen or the like. The hologram optical member according to the first configuration example of the first embodiment includes the substrate 1, the HOE layer 2 as a hologram layer, and a hard coat layer 3 disposed between the hologram layer 2 and the substrate 1.

The substrate 1 includes a resin material, for example, PMMA (Polymethyl Methacrylate). PMMA is an acrylic resin.

The hard coat layer 3 is configured to have a hardness higher than that of the substrate 1. The hardness of the hard coat layer 3 may be preferably, for example, greater than or equal to 4H and less than or equal to 6H as a pencil hardness. It is to be noted that the PMMA, which is used as the material to be included in the substrate 1, has a pencil hardness of 2H.

The hard coat layer 3 includes an organic-based material. The hard coat layer 3 is configured to include, for example, an acrylic-based resin, a silica solution, and a UV curable resin.

It is to be noted that in consideration of UV damage to the substrate 1 including the resin material, a thermoset resin may be used for the hard coat layer 3, rather than the UV curable resin. For example, the hard coat layer 3 may be configured to include a polysiloxane-based resin and a thermosetting resin. Alternatively, the hard coat layer 3 may be configured to include a silicone-based resin and a thermosetting resin. Use of the thermoset resin makes it possible to increase light resistance and extend a life.

The hard coat layer 3 may be formed, for example, by a method such as dip coating, bar coating, or slit coating. Depending on a forming method (in the case of the dip coating, for example), the hard coat layer 3 may also be provided on a surface (a surface on a lower side of the substrate 1 in FIG. 2) on an opposite side to a surface, of the substrate 1, that is provided with the HOE layer 2.

If the hard coat layer 3 has, for example, a thickness greater than or equal to 2 μm and less than or equal to 3 μm, the hard coat layer 3 is able to achieve a function to increase environment resistance.

The HOE layer 2 has, for example, a configuration in which a base, which includes polyamide, and a photopolymer resin are stacked. For example, in FIG. 2, provided is a configuration of a stack in which the base is disposed on a side (upper side) opposite to the substrate 1 and the hard coat layer 3, and the photopolymer resin is disposed on a side (lower side) of the substrate 1 and the hard coat layer 3.

As described above, because the hard coat layer 3 is on the side of the photopolymer resin of the HOE layer 2 functioning as the hologram screen, it is possible to suppress the deterioration of the diffraction characteristic of the HOE layer 2 even if the load of the actual use environment is applied.

As with the technique according to the comparative example described above, in a case where the respective surfaces of the substrate 1 and the HOE layer 2 are coated with the ambient-temperature glass, the function of the HOE layer 2 can be lost due to the thermal expansion and thermal contraction of the substrate 1 caused by the difference in the linear expansion between the ambient-temperature glass and the resin material. In a case where the technique according to the comparative example is applied to a hologram screen having a shape with a high curvature such as a cylindrical hologram screen, in particular, the ambient-temperature glass is not able to follow expansion and contraction due to the thermal expansion and thermal contraction of the substrate 1 including the resin material. In addition, although the ambient-temperature glass is able to follow bending and warping to some extent, the ambient-temperature glass is considered to easily break due to its hardness.

In contrast, because the hard coat layer 3 includes the organic-based material, the hard coat layer 3 has affinity with the substrate 1 including the resin material, and has favorable adhesion to the substrate 1. In optical terms, because a refractive index of the hard coat layer 3 is close to a refractive index of the substrate 1, Fresnel reflection is small. As a result, in a case of application to the hologram screen, loss of image light is small. The hard coat layer 3 does not need a primer, is lower in hardness than the ambient-temperature glass and therefore able to follow the expansion and contraction of the substrate 1 including the resin material, and does not easily cause a crack. In addition, the hard coat layer 3 is lower-priced than the ambient-temperature glass because a material cost is inexpensive and the primer is not necessary.

Therefore, the hologram optical member according to the first configuration example makes it possible to suppress the poor appearance due to the break, etc., and the deterioration of characteristics caused by the load of the actual use environment. In addition, it is possible to state that the hologram optical member according to the first configuration example is low-priced and lightweight, and has a high degree of freedom in shape. [Examples of Characteristics]

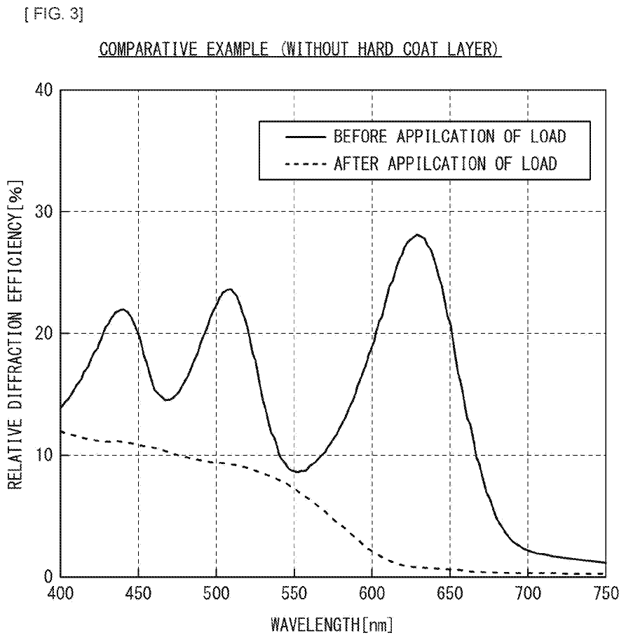

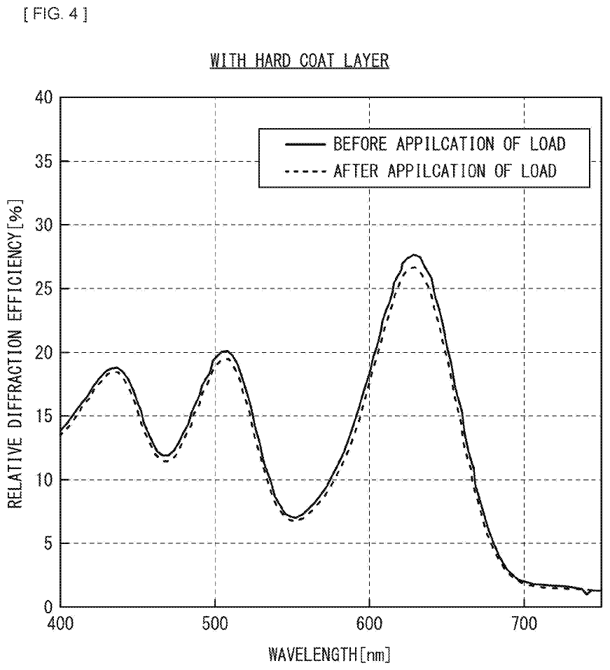

FIG. 3 illustrates an example of a diffraction characteristic of the hologram optical member (a configuration without the hard coat layer 3) according to the comparative example. FIG. 4 illustrates an example of a diffraction characteristic of the hologram optical member (a configuration with the hard coat layer 3) according to the first configuration example of the first embodiment.

In FIG. 3 and FIG. 4, a horizontal axis represents a wavelength (nm) and a vertical axis represents a relative diffraction efficiency (%). FIG. 3 and FIG. 4 each illustrate a characteristic after a load with a temperature of 60° C. and humidity of 90% is applied to the hologram optical member for a predetermined period of time (48 hours), and a characteristic before applying such a load.

As can be seen from FIG. 3, in the configuration without the hard coat layer 3, the diffraction efficiency is degraded due to the load. In contrast, as can be seen from FIG. 4, in the configuration with the hard coat layer 3, the deterioration of the diffraction efficiency due to the load is suppressed. In the configuration without the hard coat layer 3, due to the load, air bubbles are generated between the substrate 1 and the HOE layer 2, and falling off of the HOE layer 2 occurs easily.

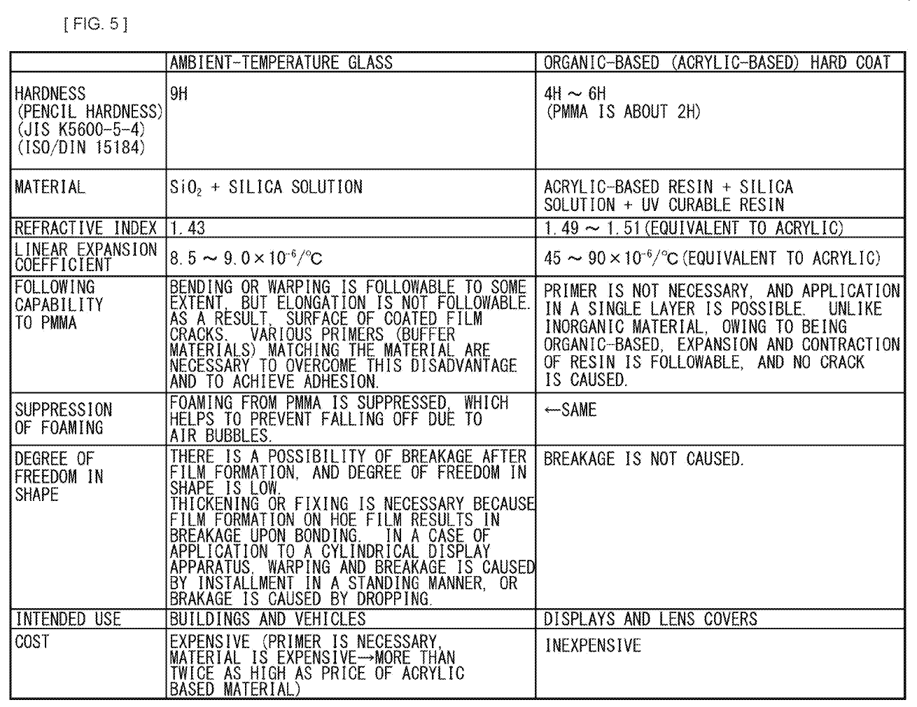

FIG. 5 presents a comparison in terms of various characteristics between the ambient-temperature glass and an organic-based hard coat.

It is to be noted that FIG. 5 presents an example in which the acrylic-based resin is used, as an example of the organic-based hard coat used in the hard coat layer 3. In terms of following capability to PMMA which is the material included in the substrate 1, the ambient-temperature glass has some following capability to bending or warping, but is not able to follow elongation. As a result, a surface of a coated film cracks. In order to overcome this disadvantage and achieve adhesion, various primers (buffer materials) matching the material are necessary. The organic-based hard coat does not need the primer, and is applicable in a single layer. Unlike an inorganic material, the organic-based hard coat is organic-based. Therefore, the organic-based hard coat is able to follow expansion and contraction of a resin, and does not cause a crack.

In terms of the degree of freedom in shape, the ambient-temperature glass can break after being formed into a film and thus has a low degree of freedom. In a case where a film of the ambient-temperature glass is formed on the HOE film, the ambient-temperature glass breaks upon bonding. Therefore, it is necessary to thicken or fix the ambient-temperature glass. In a case where the ambient-temperature glass is applied to a cylindrical display apparatus, the ambient-temperature glass can warp and break when the cylindrical display apparatus is installed in a standing manner, or can break when the cylindrical display apparatus is dropped. The organic-based hard coat does not cause a crack.

In terms of cost, the ambient-temperature glass needs the primer and is high in material price. The price of the ambient-temperature glass is more than twice as high as that of the acrylic-based and organic-based hard coat.

### [1.1.2 Hologram Optical Member Including Optical Clear Adhesive Layer]

FIG. 6 illustrates a second configuration example of the hologram optical member according to the first embodiment.

The hologram optical member according to the second configuration example of the first embodiment further includes an OCA (Optical Clear Adhesive: optical clear adhesive) layer 4, as compared with the configuration of the hologram optical member (FIG. 2) according to the first configuration example.

The OCA layer 4 is disposed between the HOE layer 2 and the hard coat layer 3. The OCA layer 4 includes a silicone-based adhesive, for example. Providing the OCA layer 4 makes it possible to improve adherence between the HOE layer 2 and the hard coat layer 3.

As described above, providing the hard coat layer 3 makes it possible to suppress deterioration of an optical characteristic with respect to the load of the actual use environment. Providing the OCA layer 4 makes it possible to further improve the environment resistance for a longer period of time.

Providing the OCA layer 4 makes it possible to further suppress falling off of the HOE layer 2. Consequently, in a case of application to a hologram screen, it is possible to maintain viewability resistance for a longer period of time, and in addition, suppresses the poor appearance and preserves designability. The HOE layer 2 exhibits the diffraction characteristic with respect to a particular angle and a particular wavelength (has high angle selectivity and high wavelength selectivity). Therefore, in the case of the application to the hologram screen, if the HOE layer 2 falls off, a light incident angle with respect to the HOE layer 2 changes. As a result, desired display can be prevented, or display quality can be degraded such as due to a change in color. Providing the OCA layer 4 makes it possible to suppress the above.

### Examples of Characteristics

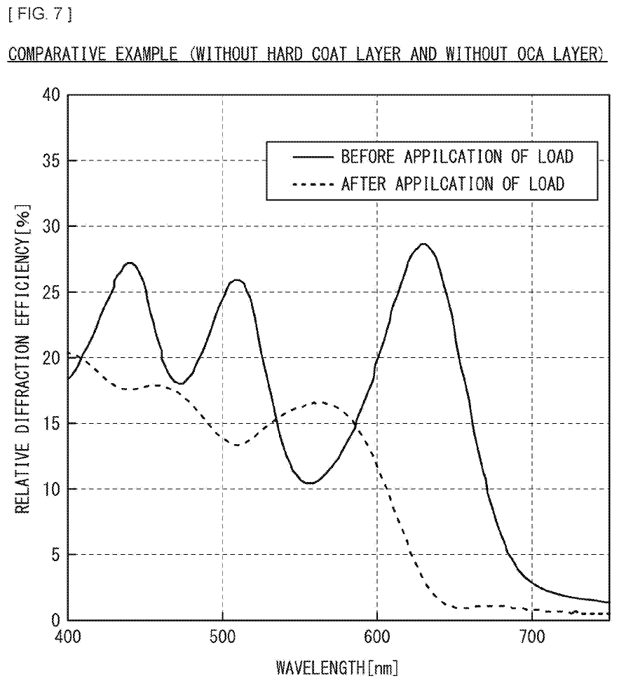

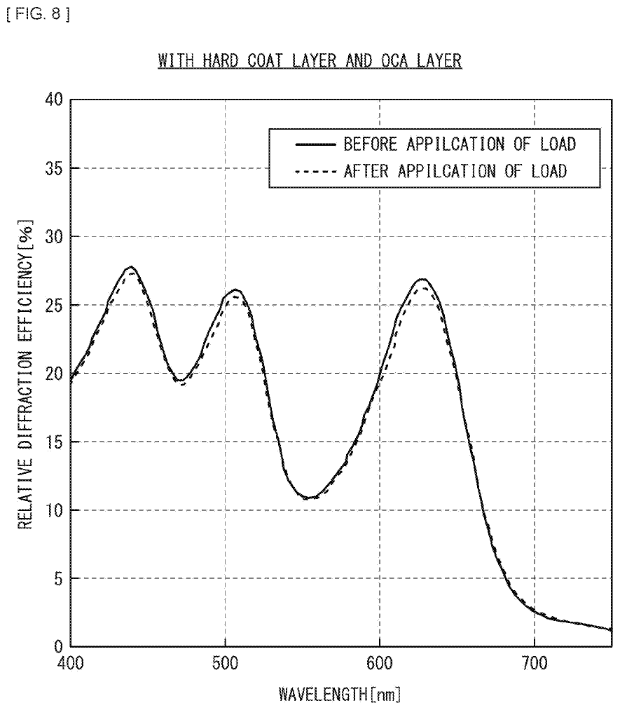

FIG. 7 illustrates an example of the diffraction characteristic of the hologram optical member (a configuration without the hard coat layer 3 and without the OCA layer 4) according to the comparative example. FIG. 8 illustrates an example of a diffraction characteristic of the hologram optical member (a configuration with the hard coat layer 3 and the OCA layer 4) according to the second configuration example of the first embodiment.

In FIG. 7 and FIG. 8, the horizontal axis represents a wavelength (nm), and the vertical axis represents relative diffraction efficiency (%). FIG. 7 and FIG. 8 each illustrate a characteristic after a load with a temperature of 60° C. and humidity of 90% is applied to the hologram optical member for a predetermined period of time (48 hours), and a characteristic before applying such a load.

As can be seen from FIG. 7, in the configuration without the hard coat layer 3 and without the OCA layer 4, the diffraction efficiency is degraded due to the load. In contrast to this, as can be seen from FIG. 8, in the configuration with the hard coat layer 3 and the OCA layer 4, the deterioration of the diffraction efficiency due to the load is suppressed.

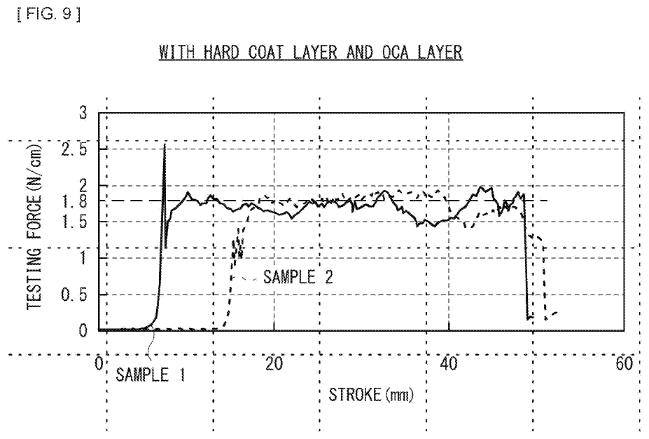

FIG. 9 illustrates an example of a result of a measurement in which a 90° falling-off test is performed on the hologram optical member (the configuration with the hard coat layer 3 and the OCA layer 4) according to the second configuration example of the first embodiment.

In FIG. 9, the horizontal axis represents a stroke (mm), and the vertical axis represents a testing force (N/cm). FIG. 9 also illustrates a result of a measurement in which the 90° falling-off test is performed on two samples (sample 1 and sample 2) having an identical configuration. It is confirmed that providing the OCA layer 4 makes it possible to maintain a certain falling-off strength. It is also confirmed that providing the OCA layer 4 makes it possible to suppress zipping or foaming.

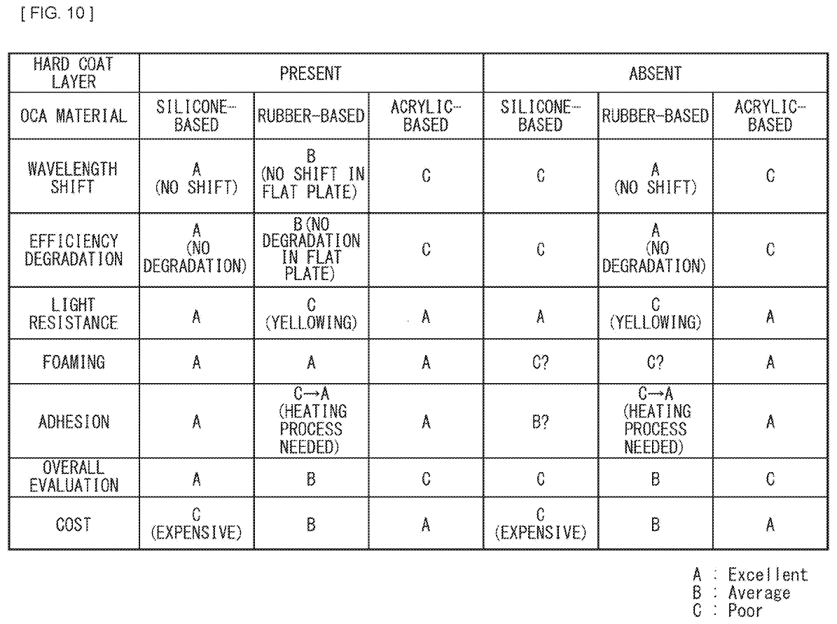

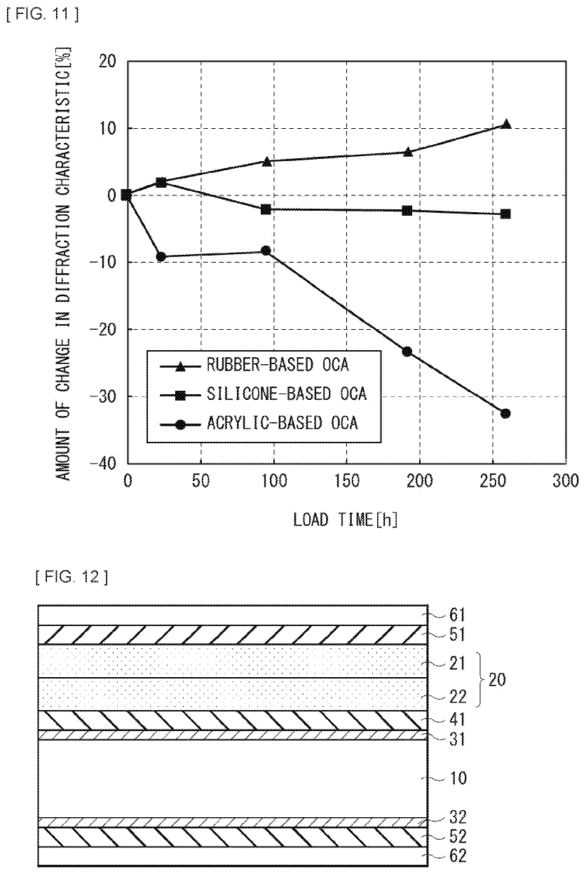

FIG. 10 presents a comparison in terms of the various characteristics between different materials to be included in the OCA layer 4. FIG. 11 presents a comparison in terms of the diffraction characteristic between different materials to be included in the OCA layer 4. In FIG. 11, the horizontal axis represents a load time (h) during which the load with the temperature of 60° C. and the humidity of 90% is applied. The vertical axis represents an amount of change (%) in the diffraction characteristic. FIG. 11 illustrates the characteristics in a case where the hologram optical member has a curved surface shape.

FIG. 10 presents the comparison in terms of the various characteristics between the different materials to be included in the OCA layer 4, for each of a case with the hard coat layer 3 and a case without the hard coat layer 3. FIG. 10 presents the comparison in terms of the various characteristics in a case where the silicone-based adhesive is used as the material included in the OCA layer 4, a case where a rubber-based adhesive is used as the material included in the OCA layer 4, and a case where an acrylic-based adhesive is used as the material included in the OCA layer 4. FIG. 10 presents an evaluation of the various characteristics in three grades of A (Excellent), B (Average), and C (Poor).

The acrylic-based adhesive is not suitable as the material to be included in the OCA layer 4 because the diffraction characteristic degrades with respect to the load, irrespective of presence or absence of the hard coat layer 3. The rubber-based adhesive has less deterioration of the diffraction characteristic in a case where the hologram optical member is flat-plate-shaped. However, in a case where the hologram optical member has the curved surface shape, initial characteristic is already degraded, as illustrated in FIG. 11. Regarding the rubber-based adhesive, a load curve still inclines after elapse of 260 h (deterioration does not reach a saturation level), and falling off or yellowing occurs if no thermal process is performed. In contrast, regarding the silicone-based adhesive compound, deterioration reaches a saturation level when the deterioration is still small, and the small deterioration state is maintained at and after the elapse of 260 h. Therefore, the silicone-based adhesive is suitable as the material to be included in the OCA layer 4.

FIG. 12 illustrates a third configuration example of the hologram optical member according to the first embodiment.

Provided may be a configuration that further includes a functional sheet for enhancing transparency or improving antifouling property, such as an AR (Anti-Reflection: anti-reflection) layer, as compared with the configuration of the hologram optical member according to the second configuration example (FIG. 6).

The hologram optical member according to the third configuration example of the first embodiment includes a substrate 10, an HOE layer 20, a first hard coat layer 31, and a first OCA layer 41. As a correspondence relationship with the configuration of the hologram optical member illustrated in FIG. 6, the substrate 10 corresponds to the substrate 1, the HOE layer 20 corresponds to the HOE layer 2, the first hard coat layer 31 corresponds to the hard coat layer 3, and the first OCA layer 41 corresponds to the OCA layer 4. A configuration of each of the substrate 10, the HOE layer 20, the first hard coat layer 31, and the first OCA layer 41 may be similar to the configuration of each of the corresponding parts of the hologram optical member illustrated in FIG. 6.

The HOE layer 20 includes, for example, a base 21, which includes polyamide, and a photopolymer resin 22. The HOE layer 20 has a configuration of a stack in which the base 21 is disposed on a side (upper side) opposite to the first OCA layer 41, and the photopolymer resin 22 is disposed on a side (lower side) of the first OCA layer 41.

The hologram optical member according to the third configuration example further includes a second hard coat layer 32, a second OCA layer 51, a third OCA layer 52, a first AR layer 61, and a second AR layer 62.

A material included in the second hard coat layer 32 may be similar to that included in the first hard coat layer 31. The second hard coat layer 32 is provided on a side (lower side) opposite to a side (upper side) where the first hard coat layer 31 is provided, with respect to the substrate 10. The third OCA layer 52 and the second AR layer 62 are stacked in order, on a side (lower side) opposite to a side (upper side) where the substrate 10 is provided, with respect to the second hard coat layer 32. The third OCA layer 52 is, for example, an acrylic-based adhesive for a countermeasure against foaming.

The second OCA layer 51 and the first AR layer 61 are stacked in order, on a side (upper side) opposite to a side (lower side) where the first OCA layer 41 is provided, with respect to the HOE layer 20.

### 1.2 Example of Application to Display Apparatus

FIG. 13 illustrates a configuration example of a display apparatus according to the first embodiment.

The display apparatus according to the first embodiment includes a cylindrical screen 100 and a pedestal 110.

An image light generator 111 and a projection optical system 112 are provided inside the pedestal 110. The pedestal 110 has a cylindrical shape and is provided on a lower side of the cylindrical screen 100.

A reflecting mirror 120 is provided at an upper portion of the cylindrical screen 100. The cylindrical screen 100 is a cylindrical hologram screen on which an image is to be displayed.

As each of the image light generator 111 and the projection optical system 112, for example, a color projector of a laser scanning method or the like is used. The color projector of the laser scanning method performs scanning with respective laser beams corresponding to colors of RGB to perform display for each pixel.

For example, as the image light generator 111, a projection apparatus (projector) including a light emitting device and a light modulation device may be appropriately used. The light emitting device includes a laser diode (LD: Laser Diode), an LED (Light Emitting Diode), or the like. The light modulation device includes a MEMS (Micro Electro Mechanical System), a DMD (Digital Mirror Device), a reflection-type liquid crystal, a transmission-type liquid crystal, or the like.

The cylindrical screen 100 has a cylindrical shape and is disposed over the entire circumference. The cylindrical screen 100 is a transmission-type hologram screen.

Image light outputted from the image light generator 111 and the projection optical system 112 is projected toward an inner side of the cylindrical screen 100 by the reflecting mirror 120. The image light entering from the inner side of the cylindrical screen 100 is diffused (scattered) in various directions and outputted to an outer side by the cylindrical screen 100. Consequently, an image is displayed over the entire circumference on the outer side of the cylindrical screen 100.

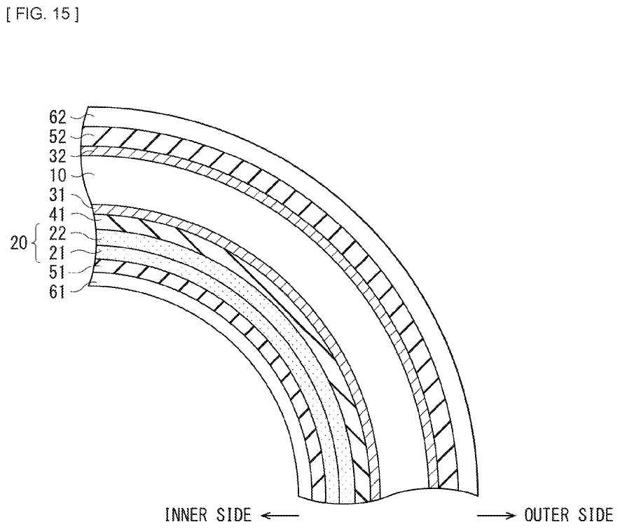

FIG. 14 illustrates a main part of a configuration example of a hologram screen according to a comparative example. FIG. 15 illustrates a main part of a configuration example of the hologram screen according to the first embodiment.

The cylindrical screen 100 may have the configuration of the hologram screen illustrated in FIG. 15. The configuration of the hologram screen illustrated in FIG. 15 may be similar to the configuration of the hologram optical member according to the foregoing third configuration example (FIG. 12), except that the hologram screen in FIG. 15 has a cylindrical shape. A side on which the first AR layer 61 is provided is an inner side, and the second AR layer 62 is on an outer side.

The hologram screen according to the comparative example illustrated in FIG. 14 has a configuration in which the first hard coat layer 31, the second hard coat layer 32, and the first OCA layer 41 are omitted, as compared with the configuration of the hologram screen illustrated in FIG. 15. In the cylindrical hologram screen, the stress due to the thermal expansion and thermal contraction of the substrate 10 including the resin material is applied in a direction toward the center of a circle, as compared with the flat-plate-shaped hologram screen. Therefore, the cylindrical hologram screen needs a configuration that does not break easily, as compared with the flat-plate-shaped hologram screen. Applying the hologram screen illustrated in FIG. 15 as the cylindrical screen 100 makes it possible to enhance the environment resistance and improve reliability in display quality.

It is to be noted that although FIG. 13 illustrates the configuration example in which the cylindrical screen 100 is the transmission-type hologram screen, the cylindrical screen 100 may be the reflection-type hologram screen.

### 1.3 Effects

As described above, according to the hologram optical member according to the first embodiment, the hard coat layer 3 (or the first hard coat layer 31) including the organic-based material is disposed between the HOE layer 2 (or the HOE layer 20) and the substrate 1 (or the substrate 10) including the resin material. This makes it possible to enhance the environment resistance. Consequently, in a case of application to a display apparatus, reliability in display quality improves.

It is to be noted that the effects described herein are merely illustrative and non-limiting, and any other effect may be achieved. This also applies to effects of the following other embodiments.

### 2. Other Embodiments

The technology according to the present disclosure is not limited to the descriptions of the foregoing embodiments, and various modifications may be made.

For example, the present technology may have the following configurations.

According to the present technology having the following configurations, a hard coat layer including an organic-based material is disposed between a hologram layer and a substrate. This makes it possible to enhance environment resistance.

(1)

A hologram optical member including:
a hologram layer;
a substrate including a resin material; and
a hard coat layer that is disposed between the hologram layer and the substrate, includes an organic-based material, and has a hardness higher than that of the substrate.
   (2)

The hologram optical member according to (1) described above, in which the hardness of the hard coat layer is higher than or equal to 4H and lower than or equal to 6H as a pencil hardness.

(3)

The hologram optical member according to (1) or (2) described above, in which the hard coat layer includes an acrylic-based resin, a silica solution, and a UV curable resin.

(4)

The hologram optical member according to (3) described above, in which the hard coat layer has a refractive index that is higher than or equal to 1.49 and lower than or equal to 1.51.

(5)

The hologram optical member according to (3) or (4) described above, in which the hard coat layer has a linear expansion coefficient that is from 45(x 10⁻⁶/° C.) to 90(×10⁻⁶/° C.).

(6)

The hologram optical member according to any one of (3) to (5) described above, in which the hard coat layer has a thickness that is greater than or equal to 2 μm and less than or equal to 3 μm.

(7)

The hologram optical member according to (1) or (2) described above, in which the hard coat layer includes a polysiloxane-based resin and a thermosetting resin.

(8)

The hologram optical member according to (1) or (2) described above, in which the hard coat layer includes a silicone-based resin and a thermosetting resin.

(9)

The hologram optical member according to any one of (1) to (8) described above, further including an optical clear adhesive layer that is disposed between the hologram layer and the hard coat layer.

(10)

The hologram optical member according to any one of (1) to (9) described above, in which the optical clear adhesive layer includes a silicone-based adhesive.

(11)

The hologram optical member according to any one of (1) to (9) described above, in which the hologram layer, the substrate, and the hard coat layer each have a curved surface shape.

(12)

A hologram screen including:
including:
a hologram layer;
a substrate including a resin material; and
a hard coat layer that is disposed between the hologram layer and the substrate, includes an organic-based material, and has a hardness higher than that of the substrate.
   (13)

A display apparatus including
a hologram screen that displays an image,
the hologram screen including
a hologram layer,
a substrate including a resin material, and
a hard coat layer that is disposed between the hologram layer and the substrate, includes an organic-based material, and has a hardness higher than that of the substrate.
   (14)

The display apparatus according to (13) described above, in which the hologram screen has a cylindrical shape.

This application claims the priority on the basis of Japanese Patent Application No. 2021-35855 filed on Mar. 5, 2021 with Japan Patent Office, the entire contents of which are incorporated in this application by reference.

It should be understood by those skilled in the art that various modifications, combinations, sub-combinations and alterations may occur depending on design requirements and other factors insofar as they are within the scope of the appended claims or the equivalents thereof.

1. A hologram optical member comprising:
a hologram layer;
a substrate including a resin material; and
a hard coat layer that is disposed between the hologram layer and the substrate, includes an organic-based material, and has a hardness higher than that of the substrate.

2. The hologram optical member according to claim 1, wherein the hardness of the hard coat layer is higher than or equal to 4H and lower than or equal to 6H as a pencil hardness.

3. The hologram optical member according to claim 1, wherein the hard coat layer includes an acrylic-based resin, a silica solution, and a UV curable resin.

4. The hologram optical member according to claim 3, wherein the hard coat layer has a refractive index that is higher than or equal to 1.49 and lower than or equal to 1.51.

5. The hologram optical member according to claim 3, wherein the hard coat layer has a linear expansion coefficient that is from 45(×10⁻⁶/° C.) to 90(×10⁻⁶/° C.).

6. The hologram optical member according to claim 3, wherein the hard coat layer has a thickness that is greater than or equal to 2 μm and less than or equal to 3 μm.

7. The hologram optical member according to claim 1, wherein the hard coat layer includes a polysiloxane-based resin and a thermosetting resin.

8. The hologram optical member according to claim 1, wherein the hard coat layer includes a silicone-based resin and a thermosetting resin.

9. The hologram optical member according to claim 1, further comprising an optical clear adhesive layer that is disposed between the hologram layer and the hard coat layer.

10. The hologram optical member according to claim 1, wherein the optical clear adhesive layer includes a silicone-based adhesive.

11. The hologram optical member according to claim 1, wherein the hologram layer, the substrate, and the hard coat layer each have a curved surface shape.

12. A hologram screen comprising:
a hologram layer;
a substrate including a resin material; and
a hard coat layer that is disposed between the hologram layer and the substrate, includes an organic-based material, and has a hardness higher than that of the substrate.

13. A display apparatus comprising
a hologram screen that displays an image,
the hologram screen including
a hologram layer,
a substrate including a resin material, and
a hard coat layer that is disposed between the hologram layer and the substrate, includes an organic-based material, and has a hardness higher than that of the substrate.

14. The display apparatus according to claim 13, wherein the hologram screen has a cylindrical shape.
